(19) United States
(12) Patent Application Publication
(10) Pub. No.: US 2016/0012987 A1
(43) Pub. Date: Jan. 14, 2016

(54) Household Electrical Appliance Control Panel and Method of Manufacturing Such a Control Panel

(71) Applicant: SEB S.A., Bois, Ecully (FR)

(72) Inventors: Jean-Louis Deshayes, Averton (FR); Stéphane Retour, Commer (FR); Emmanuel Gerard, Couterne (FR)

(21) Appl. No.: 14/772,536

(22) PCT Filed: Feb. 27, 2014
(86) PCT No.: PCT/FR2014/050434

§ 371 Date: Sep. 3, 2015

(30) Foreign Application Priority Data
Mar. 8, 2013 (FR) 1352102

(51) Int. Cl. H01H 13/70; A47J 43/046

(52) U.S. Cl. CPC H01H 13/70; A47J 43/046

(57) ABSTRACT

Household electrical appliance control panel (6) comprising a membrane (7) with blisters (70) defining the keys of the control panel (6) and a backing piece (8) to which the membrane (7) is attached, the backing piece (8) having openings (80) opposite said blisters (70), wherein the membrane (7) and the backing piece (8) are respectively made of a first and a second chemically non-metallizable material and wherein the backing piece (8) comprises at least one part that is not covered by the membrane (7) and onto which a decorative piece (9) of chemically metallizable material is overmoulded, the decorative piece (9) having an external surface which is chemically metallized.

The present invention relates to the general technical field of household electrical culinary appliance control panels comprising a membrane, advantageously of polyester, supported by a backing piece, the membrane comprising blisters defining keys of the control panel and the backing piece comprising openings opposite the blisters designed to receive a switch.

A control panel comprising a semi-rigid plastic membrane including blisters having the shape of an outwardly turned spherical cap, the membrane being glued onto a backing piece, is disclosed in patent application FR 2 647 588. Such a control panel with a blister membrane has the advantage of ensuring not only a protective seal of the electrical parts of the control panel, but also a flexibility of the keys that gives rise to good ergonomics of use.

However, such a control panel has the disadvantage of possessing a rather dull and low-quality appearance. Furthermore, such a control panel has the disadvantage that infiltrations can occur at the periphery of the membrane, at the joint with the housing of the appliance.

An object of the present invention is thus to propose a control panel with an improved appearance that is simple and economical to manufacture and a manufacturing method for making such a control panel. Another object of the present invention is to propose a control panel in which the infiltration risks are limited.

To this end, the invention relates to a household electrical appliance control panel comprising a membrane supported by a backing piece, the membrane comprising blisters defining the keys of the control panel, the backing piece comprising openings opposite the blisters designed to receive a switch, characterized in that the membrane and the backing piece are respectively made of a first and a second chemically non-metallizable material, and in that the backing piece comprises at least one part not covered by the membrane, onto which a chemically metallizable decorative piece is overmolded, the decorative piece comprising an external surface which is wet metallized by jointly immersing the backing piece, the membrane, and the decorative piece in a bath containing the metal to be deposited on the decorative piece.

According to another feature of the invention, the membrane is made of polyester.

According to another feature of the invention, the backing piece is made of polycarbonate or of a material belonging to the family of copolyesters.

According to still another feature of the invention, the decorative piece is made of ABS (Acrylonitrile Butadiene Styrene).

According to still another feature of the invention, the decorative piece is chrome plated.

According to another feature of the invention, the backing piece is overmolded onto the membrane.

According to another feature of the invention, the membrane is transparent and comprises a bottom side on which is printed the design of the control panel and in particular labeling for the keys.

According to another feature of the invention, the backing piece is transparent, the bottom side of the membrane comprising an area without printing, the area forming a window of the control panel allowing visual access to a display unit.

The invention also relates to a household electrical culinary appliance comprising a control panel as previously described.

The invention also relates to a method of manufacturing a household electrical culinary appliance control panel comprising a membrane comprising an upper side having blisters in the vicinity of keys, the membrane being made of a first chemically non-metallizable material, characterized in that
a backing piece comprising openings opposite the blisters is attached to the bottom side of the membrane, the backing piece being made of a second chemically non-metallizable material,
a decorative piece is overmolded onto at least a part of the backing piece and/or of the membrane, the decorative piece being made of a chemically metallizable material,
the decorative piece is wet-chemically metallized.

According to another feature of the invention, the decorative piece is chrome plated by jointly immersing the backing piece, the membrane, and the decorative piece in a chrome bath.

According to another feature of the invention, the backing piece is overmolded onto the membrane.

According to another feature of the invention, the membrane is made of transparent polyester.

According to another feature of the invention, labeling is printed on the bottom side of the membrane prior to the phase of overmolding the backing piece onto the membrane.

According to another feature of the invention, the backing piece is made of polycarbonate or of a material belonging to the family of copolyesters.

According to another feature of the invention, the decorative piece is made of ABS (Acrylonitrile Butadiene Styrene).

The objects, aspects, and advantages of the present invention will emerge more clearly from the following description of a special embodiment of the invention, which is given as a non-limiting example and which refers to the appended drawings.

Shown are:

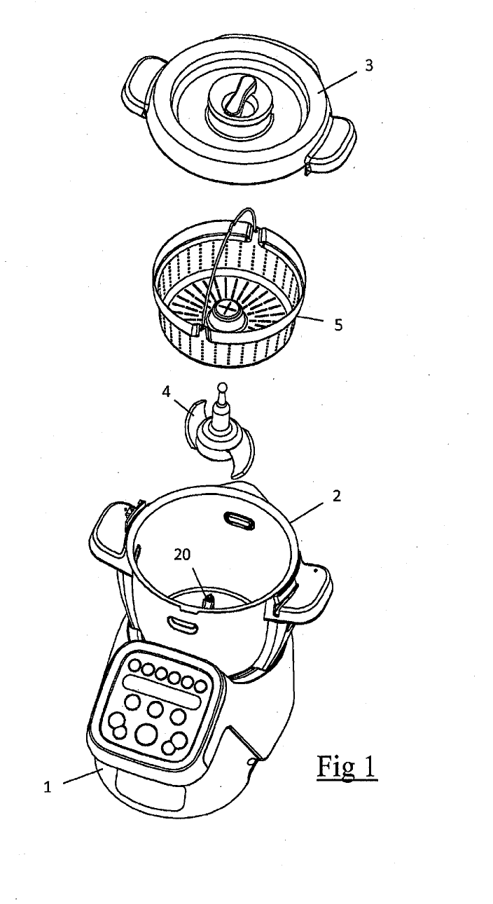

FIG. 1 is an exploded perspective view of a culinary appliance according to a special embodiment of the invention;

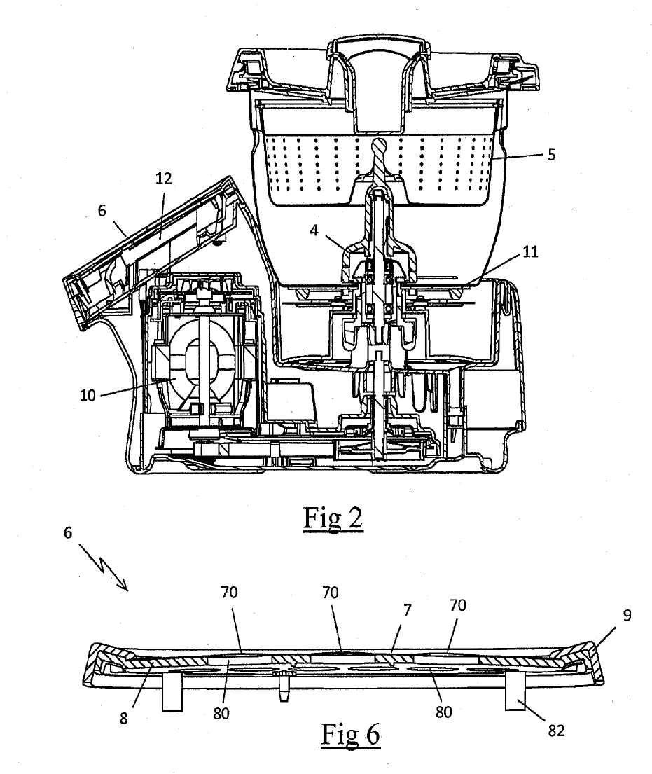

FIG. 2 is a longitudinal sectional view of the appliance of FIG. 1;

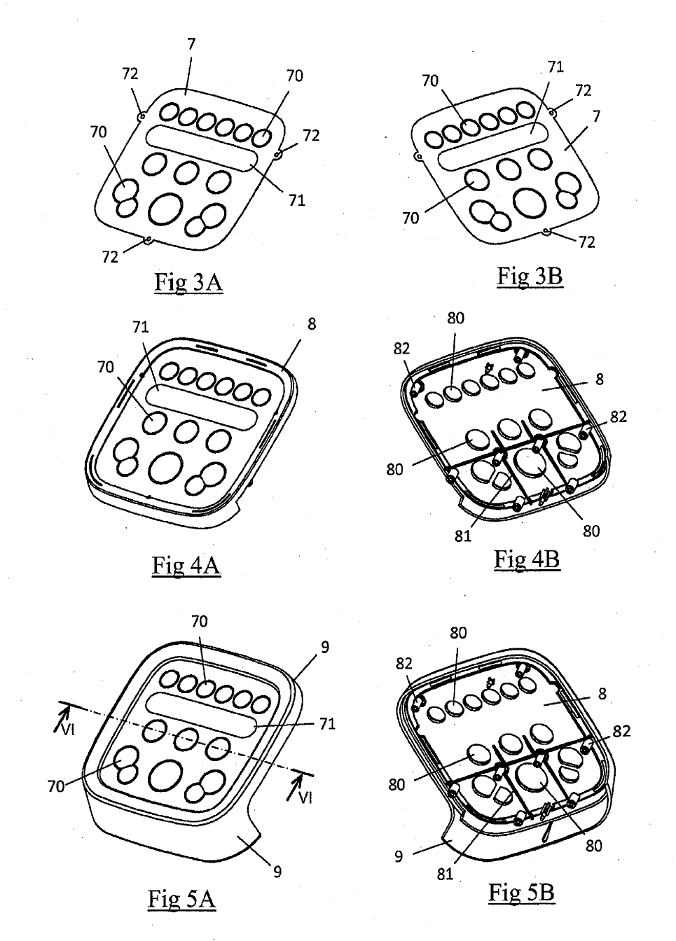

FIGS. 3A and 3B are perspective views from above and below, respectively, of the blister membrane of the control panel equipping the appliance of FIG. 1;

FIGS. 4A and 4B are perspective views from above and below, respectively, of the control panel after the first phase of molding the backing piece onto the back of the membrane;

FIGS. 5A and 5B are perspective views from above and below, respectively, of the control panel after the phase of molding the plastic decorative piece;

FIG. 6 is a cutaway view of the control panel along the line VI-VI of FIG. 5A.

Only the elements necessary for understanding the invention have been illustrated. To make the drawings easier to read, the same elements have the same reference signs from one figure to the other.

FIGS. 1 and 2 illustrate a culinary appliance comprising a housing 1 supporting a detachable work container 2 equipped with a lid 3, the work container 2 comprising a bottom equipped with a rotary drive 20 connected by a kinematic chain to a motor 10, which is only visible in FIG. 2, the drive 20 capable of receiving a tool 4 for chopping food placed in the bottom of the work container 2.

The work container 2 is advantageously made of stainless steel and is seated on a heating plate 11 integrated in the housing 1, the heating plate 11 comprising a bottom side equipped with a resistor, specifically a shielded resistor, for heating the contents of the work container 2, the top part of the work container being capable of receiving a basket 5 for steam cooking.

The heating plate 11 and the motor 10 are controlled in a manner known per se by a circuit board 12 positioned under a control panel 6 present on a front side of the housing 1, wherein this circuit board 12 receives the value of the temperature measured by a temperature sensor and controls the power supply to the heating plate 11 in such a way as to bring the contents of the work container 2 to a set temperature.

According to FIGS. 3A and 3B, the control panel 6 comprises a transparent membrane 7 made of a first chemically non-metallizable material, preferably polyester, wherein the membrane 7 has an upper side comprising a keyboard equipped with keys formed by blisters 70 which, when pressed, cooperate with switches borne by the circuit board and not shown in the figures.

Advantageously, the blisters 70 have the form of a spherical cap with the convex side oriented toward the outside of the control panel 6, and a design incorporating labeling (not shown in the figures) in the vicinity of each blister 70 for illustrating the function of the keys is printed on the bottom side of the membrane 7.

For example, the bottom side of the membrane 7 is covered with a black color over most of its surface area and comprises labeling of a different color in the vicinity of the blisters 70 for illustrating the function of the keys, the membrane 7 maintaining an area 71 free of any printing, which defines a window allowing visual access to a display unit borne by the circuit board 12.

According to FIGS. 4A, 4B, and 6, the membrane 7 is attached to a transparent backing piece 8 comprising openings 80 opposite the blisters 70, the backing piece 8 being advantageously overmolded onto the bottom side of the membrane 7 and comprising a peripheral edge covering the perimeter of the upper surface of the membrane 7.

The backing piece 8 is made of a second chemically non-metallizable plastic material, for example polycarbonate or a plastic material of the family of copolyesters such as Tritan™ marketed by Eastman, and has a bottom side comprising ribs 81 for reinforcing the rigidity of the backing piece 8 as well as studs 82 for fastening the circuit board 12.

This overmolding operation is carried out by placing the membrane 7 in a mold, the backing piece 8 comprising three positioning holes 72 cooperating with pins of the mold for ensuring the correct positioning of the membrane 7, and then injecting the second plastic material into the mold after closing the latter.

According to FIGS. 5A, 5B, and 6, the control panel 6 comprises a decorative piece consisting of a frame 9 that is overmolded onto the backing piece 8, wherein this frame 9 is made of a chemically metallizable material such as, for example, ABS (Acrylonitrile Butadiene Styrene) plastic.

The subassembly comprising the membrane 7, the backing piece 8, and the frame 9 thus assembled is then passed in its entirety through a chrome bath for the coating (by galvanization) of the external surface of the frame 9. Given that only the plastic material of the frame 9 lends itself to being chrome plated, a chrome layer adheres to the frame 9 but not to the membrane 7 and the backing piece 8.

A control panel that is simple and economical to manufacture and equipped with a chrome plated frame that enhances the quality of the keyboard, for which the risk of infiltration via the control panel is eliminated owing to the tight seal that forms between the membrane, the backing piece, and the frame during the overmolding operations, the periphery of the membrane being furthermore sandwiched between the backing piece and the frame, is thus obtained.

Obviously the invention is not limited in any way to the embodiment described and illustrated here, which was given solely as an example. Modifications are still possible, specifically as regards the composition of various elements or by substituting equivalent techniques, without in any way exceeding the scope of protection of the invention.

In an alternative embodiment that is not illustrated, the frame could thus be coated with a metal other than chromium, for example with copper.

In another alternative embodiment that is not illustrated, the backing piece could be made of another kind of material that does not lend itself to chemical metallization, such as polypropylene or polyamide.

1. A household electrical appliance control panel comprising a membrane supported by a backing piece, the membrane comprising blisters defining keys of the control panel, the backing piece comprising openings opposite said blisters designed for receiving a switch, wherein the membrane and the backing piece are respectively made of a first and a second chemically non-metallizable material and wherein the backing piece comprises at least one part not covered by the membrane, onto which a decorative piece made of chemically metallizable material is overmolded, the decorative piece comprising an external surface which is wet metallized by jointly immersing the backing piece, the membrane, and the decorative piece in a bath containing the metal to be deposited on the decorative piece.

2. The control panel as in claim 1, wherein the membrane is polyester.

3. The control panel as in claim 1, wherein the backing piece is made from one of a polycarbonate or of a material belonging to the family of copolyesters.

4. The control panel as in claim 1, wherein the decorative piece is made of ABS (Acrylonitrile Butadiene Styrene).

5. The control panel as in claim 1, wherein the decorative piece is chrome plated.

6. The control panel as in claim 1, wherein the backing piece is overmolded onto the membrane.

7. The control panel as in claim 1, wherein the membrane is transparent and comprises a bottom side on which a design of the control panel, specifically labeling for the keys, is printed.

8. The control panel as in claim 7, wherein said backing piece is transparent and wherein the bottom side of the membrane comprises an area without printing, said area forming a window of the control panel for allowing visual access to a display unit.

9. A household electrical culinary appliance, comprising a control panel as in claim 1.

10. A method of manufacturing a control panel of a household electrical culinary appliance, comprising a membrane comprising an upper side having blisters a vicinity of keys, the membrane being made of a first chemically non-metallizable material, wherein
a backing piece comprising openings opposite the blisters is attached to a bottom side of the membrane, the backing piece being made of a second chemically non-metallizable material,
a decorative piece is overmolded onto at least a part of the backing piece and/or of the membrane, the decorative piece being made of a chemically metallizable material,
the decorative piece is wet-chemically metallized.

11. The method of manufacturing as in claim 10, wherein the decorative piece is chrome plated by jointly immersing the backing piece, the membrane, and the decorative piece in a chrome bath.

12. The method of manufacturing as in claim 10, wherein the backing piece is overmolded onto the membrane.

13. The method of manufacturing as in claim 10, wherein the membrane is made of transparent polyester.

14. The method of manufacturing as in claim 13, wherein labeling is printed on the bottom sided of the membrane prior to the step of overmolding the backing piece onto the membrane.

15. The method of manufacturing as in claim 10, wherein the backing piece is made from one of polycarbonate or of a material belonging to the family of copolyesters.

16. The method of manufacturing as in claim 10, herein the decorative piece is made of ABS (Acrylonitrile Butadiene Styrene).
